(19) United States
(12) Patent Application Publication
(10) Pub. No.: US 2015/0012375 A1
(43) Pub. Date: Jan. 8, 2015

(54) Bidding System for Last Minute Availability

(71) Applicant: Fernando A. Roiter, North Miami, FL (US)

(72) Inventor: Fernando A. Roiter, North Miami, FL (US)

(21) Appl. No.: 14/324,141

(22) Filed: Jul. 4, 2014

Related U.S. Application Data
(60) Provisional application No. 61/843,287, filed on Jul. 5, 2013.

(51) Int. Cl. G06Q 30/08

(52) U.S. Cl. CPC G06Q 30/08
USPC 705/26.3

(57) ABSTRACT

The present invention is a method of buying and selling a service between a customer and a service provider, a system for buying and selling services that may go unused, and a non-transitory computer-readable storage medium device carrying one or more sequences of one or more instructions which, when executed by one or more persons, cause an apparatus to perform said method and system. The method generally comprises submitting a bid for buying a service by the customer in a database; setting an expiration date for acceptance of the bid by the service provider into the database; and accepting the bid in the database by the service provider for selling the service.

### RELATED APPLICATIONS

This application claims priority to U.S. Provisional Application No. 61/843,287 filed Jul. 5, 2013. The entire contents of the above application are hereby incorporated by reference as though fully set forth herein.

### FIELD

The present invention relates to the field of buying and selling goods and services between a customer and service provider. More specifically, the present invention relates to a non-transitory computer-readable storage medium, method and system for buying and selling goods and services with empty stock that loses value if they are not purchased or used.

### BACKGROUND

Many times airplanes, sport events, hotels, music events, trains, rental cars, cruises, and other events, activity, or transportation methods have empty stock (seats, rooms, or the corresponding description) that go unused and when these are unused they lose 100% of their value or most of it. There have been several attempts in the prior art to maximize the sales of empty stock. For example, service providers rely on special offers in advance to try and fill empty stock. However, the service providers are limited in that they do not have the chance to fill the empty stock purchases at a close proximity to the event taking place, such as a concert, flight, cruise, etc. Additionally, customers are only able to review and purchase empty stock from published rates.

### BRIEF SUMMARY OF THE INVENTION

It is the object of the present invention to address several challenges in previous attempts to maximize profits on empty stock. The system allows for users to say how much they would like to pay and gives the possibility to the providers to fill empty capacity and maximize profits not having to publish lower rates ahead of time and having the chance to wait until a certain deadline depending on the user's preference to accept a bid.

As stated above, many times airplanes, sport events, hotels, music events, trains, rental cars, cruises, and other events, activity, or transportation methods have empty stock (seats, rooms, or the corresponding description) that go unused and when these are unused they lose 100% of their value or most of it. The invention claimed here solves this problem. By allowing all users to use a computer, or mobile device to place a bid for the service they desire inputting certain criteria, this system allows providers of service to fill empty capacity accepting these mentioned bids at different prices set by the user.

The bids have an expiration date or time that is calculated either by the expiration of the service or product they want or at a specified time by the user. The consumer bids on a product or service and has to add an expiration date or time to their bid related to the service or product they want. For example, in the case of an airline the user places a bid with an expiration of 3 hours before the airplane takes off. This means the airline can accept the bid of the user if and only if the flight the provider selects a flight that departs 3 hours or more from the moment that they selected the bid and flight. In the case of a Broadway show, if the consumer selected 6 hours before the show bid expiration, the theatre has until 6 hours before the show starts on the date selected by the consumer to accept the bid.

In one embodiment of the present invention, a method of buying and selling a service between a customer (or consumer) and a service provider, respectively, is disclosed and described herein. The method generally comprises submitting a bid for buying a service by the customer into a database; setting an expiration date for acceptance of the bid by the service provider into the database; and accepting the bid in the database by the service provider for selling the service.

In another embodiment of the present invention, a system for buying and selling services that may go unused is disclosed and described herein. The system generally comprises a consumer database having a plurality of consumers for buying a service; a service provider database having a plurality service providers for selling a service; and a bids database, wherein the consumers in the consumer database submit bid bids for buying a service into the bids database, and the service providers in the service provider database may search and accept bid bids in the bids database for their service.

A further embodiment of the present invention is a non-transitory computer-readable storage medium carrying one or more sequences of one or more instructions which, when executed by one or more processors, cause an apparatus to at least perform the following steps: bidding on a service by a customer; setting an expiration date by the customer for acceptance of the bid by a service provider; and accepting the bid of the customer by the service provider.

### BRIEF DESCRIPTION OF THE DRAWINGS

FIG. 1 is flow chart detailing the basic embodiments of the present invention.

FIG. 2 is flow chart detailing a “co-buying” aspect of the present invention.

FIG. 3 is a flow chart detailing credit card processing aspect of the present invention.

### DETAILED DESCRIPTION

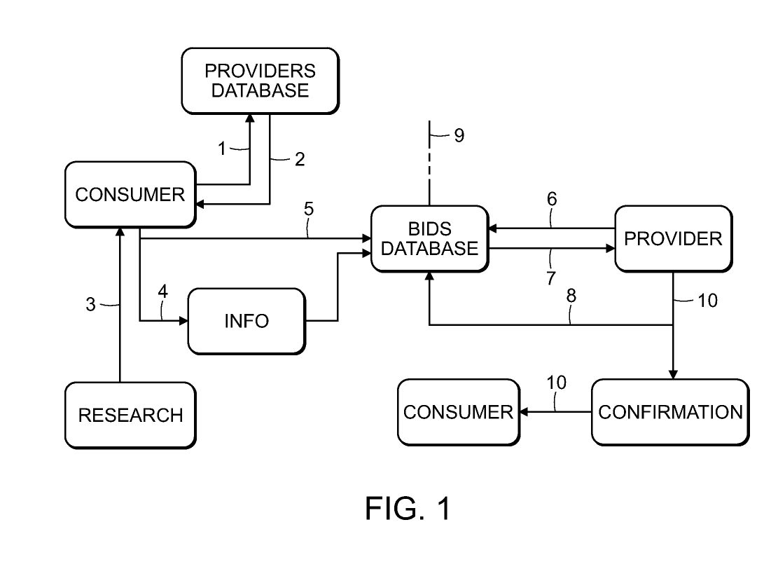

Turning to FIG. 1, (1) consumers accesses the provider database with a computer or mobile device to search the providers' database of services and (2) providers' database information is reviewed by the consumer. (3) The consumer selects a service based on consumer research and (4) the user inputs the required information required for each type of service, places a bid for the cost of the service and puts a deadline for their bid to be accepted by the service provider, this date is the day until which the service provider can accept the bid. (5) All bids go into a database, with each type of service having its own database of bids. For bids to be put in the corresponding database the consumers must have a credit card associated with their profile and the credit card is verified. Once the bid expiration date is past the bid disappears from the database of all bids. (7) When service providers decide they need to fill some seats, or rooms, or other types of empty stock, they access this system and search for it. For example, if it's an airline they look for people who want to travel on a certain date to a certain place, hotel the same, in the case of events they look for the date and event name, and so on depending on the industry. (8) The provider can accept the bid and the credit card that is on file corresponding to the bid accepted is charged. Providers can accept a bid using an automated system to accept bids of a certain price and fulfilling certain characteristics at a certain point in time before the service takes place.

(10) Once the bid is accepted by the provider and payment rendered, a confirmation number issued by the provider or by the system. (11) The consumer is notified of the acceptance and receives a confirmation, which may be via email, text or any other designated form of communication.

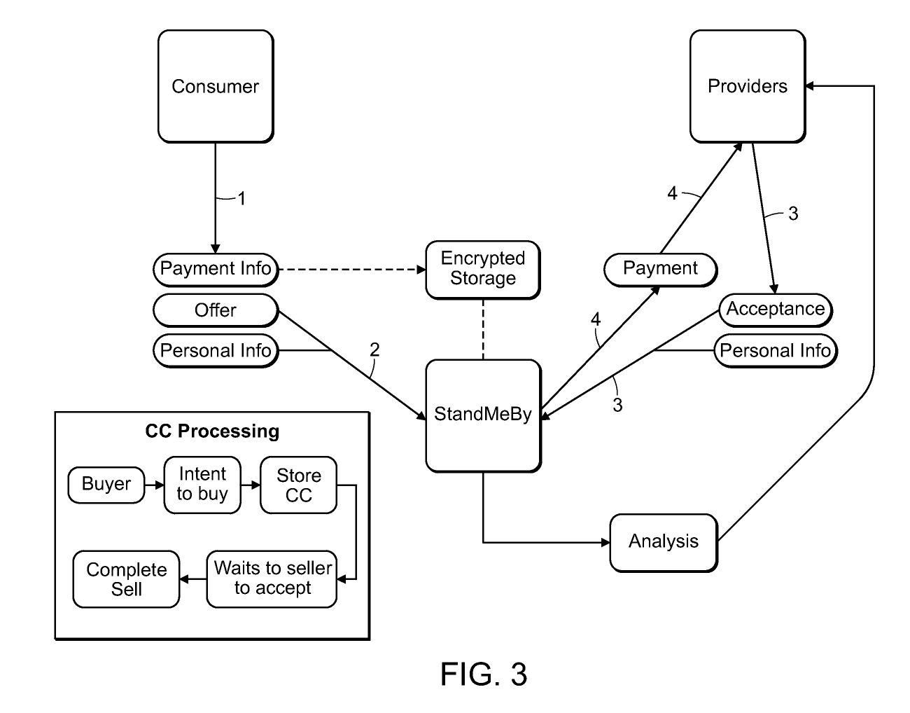

As shown further in FIGS. 1-3, consumers access the system (website or mobile application) and either log in or continue as a guest until the bidding moment where the user will have to either create a profile or access a previously created profile. Once in the website or mobile application the consumer will browse to see events or travel plans ending soon as promotions or the consumer will be able to search for their desired service. Consumers search applying certain filters. Once they input what they were looking for or they find something appealing they fill out the bid with the required information for each type of industry. This information is required so once a bid is awarded the provider of the service has all the required information to process the reservation and all bids includes a monetary value that marks the value of the bid in terms of the bid placed by the consumer. This action submits an bid to a bids database that stores their credit card information, full name, date of birth, address, price for service, expiration of bid (consumer chooses for example between 48, 36, 24, 12 hours before the time that the specified event takes place). All information related to the bids is stored on secure servers. However, a 3rd party vendor that is in charge of processing and storing credit cards may process the credit card information.

The consumer chooses any date of expiration but after that expires it disappears from the list of bids that the provider can see in the bids database. Consumers can make as many bids as desired by them and the consumer can cancel them as well. The only moment where bids are not possible to be canceled is when the service provider already accepts them.

All bids go to a bids database where the providers can search them with a separate login and access to the system. Bids will be arranged by event and from that database of the particular events the providers will be able to arrange by expiration date, price, amount, frequent customer, etc. Providers will be able to select an option to automatically accept a certain amount of bids (based on quantities of available that they input); this selection could be done based on price on the bids available at the time specified.

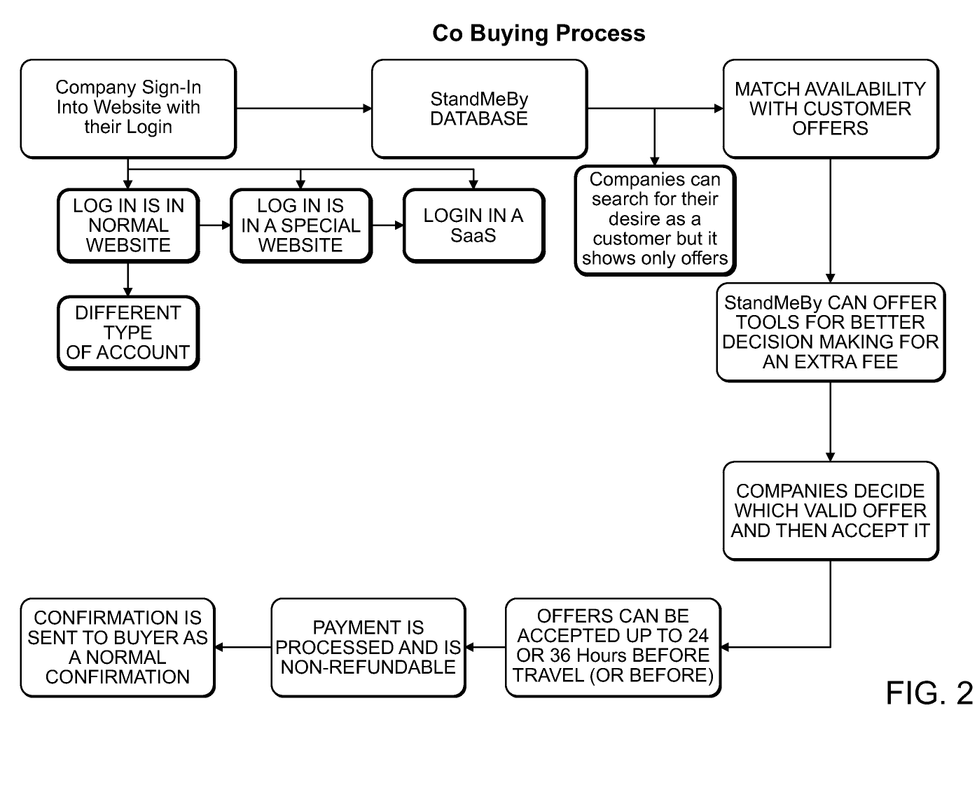

Providers could get together and bid the service together through a co-buying process shown in further detail in FIG. 2. For example, air travel with 1 stop each route could be accepted by multiple providers. The provider states that it could fulfill only one part and how much % of the price will take which leaves it open for other providers to complete the travel request and accept the bid. Once accepted, the bid is 100% fulfilled and accepted the consumer can see it. It should be noted that consumer has to provide that they would accept multiple service providers for the service.

Once a provider chooses a bid from the database, the consumer is notified and is informed of the reservation number, location, and other details of their purchase. The bid at this point is taken out of the bids database and no other providers can see it, thus working on a first come first served basis. Once the bid is accepted, the information is passed through to the provider to emit the purchased ticket.

The consumer will choose their type of bid either event, air travel, cruise, car rental, hotel stay, or entertainment and fill out their mandatory fields along with the credit card to be kept on file for processing in case of acceptance by a provider. The consumer has no option of choosing which providers may view or accept the bid but is assured the provider is going to comply with the minimum requirements of the bid. Once a bid is accepted there are no refunds. All bids made by the consumers are saved and kept in a database accessible to the providers of different services. Each provider will have access to the database that is relevant to them and in their database they can search for even more precise results. Providers can accept a bid using an automated system to accept bids of a certain price and fulfilling certain characteristics at a certain point in time before the service takes place or may manually search and accept bids. Consumers wait until the date of their deadline and if their bids weren't accepted by the deadline then that bid disappears from the database accessible to the providers. Once a bid is accepted it also disappears from the corresponding bid database. A consumer may also cancel a bid as long as a provider has not already accepted it.

The present invention requires programming software (website and mobile application) using various or one computer programming language known in the prior art, that is able to complete the requisite tasks and provide consumers and providers with the useful tools describe above. A comparison with prices of regular priced services could be added to compare at the moment of placing the bid. A post bidding-acceptance part may be added where the consumer can buy other things related to the winning bid such as a tour after winning a bid for an airline ticket. Sign in or sign up could use 3rd parties apps such as Facebook, twitter of Google+ sign up. Alerts could be added for providers if a bid is place at a certain price or automatic acceptance. Also alerts for users to be alerted when certain event or service is accepted at a price point.

Other embodiments of the present invention may function without the expiration date of the bid, may wait until last minute and lower prices of products and receive bids to those or give providers the option to accept another price close to the day of time of the service.

The system collects all the bids for a certain event or service in time. Bids do not expire until 12, 24, 48 hours, or other time established by the consumer before the date of the service. As all bids are being posted, providers have the chance to choose from all bids and select the ones that they find most appropriate for their purposes. Choices by providers can be based in the qualities that each bid has such as quantity needed, price, availability, and frequent customer.

Consumers will search for their services, goods or events. Once they find it, they will input certain requirements, these requirements depend on the industry and type of selection. The consumer makes a bid including their credit card information, full name, date of birth, address, price for article, and expiration of the bid. All information related to the bid will be stored on secure servers. All bids go into the bids database and then each provider can access with their sign in and see the bids relevant to them.

The present invention could be automatized and used in other industries. Such as daily living aspects of life such as hair salon, for the shipping industry, or other various industries that may have “empty stock.”

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method of buying and selling a service between a customer and a service provider, respectively, the method comprising:
submitting a bid offer for buying a service by the customer into a database;
setting an expiration date for acceptance of the bid offer by the service provider into the database; and
accepting the bid offer in the database by the service provider for selling the service.

2. The method of claim 1, wherein the service is an activity or event that has empty stock.

3. The method of claim 1, further comprising the service provider accessing the database, with a computer or mobile device, and inputting details of the service into the database and the consumers accessing the bids database, with a computer or mobile device, and inputting details of their bid offers into the bids database.

4. The method of claim 1, wherein multiple bid offers and multiple expiration dates for the bid offers are set by the customer in the database.

5. The method of claim 1, wherein the bid offer is saved on the database if the customer inputs a verified credit card to back the bid offer.

6. The method of claim 1, wherein the bid offer is stored on a computer database.

7. The method of claim 1, wherein if the expiration date of the bid offer passes, if the customer cancels the bid or if the bid offer is accepted by the service provider, the bid offer disappears from the database.

8. The method of claim 1, wherein possible service providers choose a bid offer in the database they find suitable to them.

9. The method of claim 1, wherein payment is made with a credit card of the customer when the bid offer is accepted by the service provider.

10. The method of claim 1, wherein the possible service providers use an automated system to accept bid offers of a certain price and certain characteristics at a certain point in time before the service takes place.

11. The method of claim 1, further comprising the service provider notifying the customer of the acceptance of their bid offer by email or by issuing a confirmation number wherein customer receives a alert of acceptance via email, text or other communication means.

12. A system for buying and selling services that may go unused, comprising:
a consumer database having a plurality of consumers for buying a service;
a service provider database having a plurality service providers for selling a service; and
a bids database, wherein the consumers in the consumer database submit bid offers for buying a service into the bids database, and the service providers in the service provider database may search and accept bid offers in the bids database for their service.

13. The system of claim 12, wherein the service is an activity or event that has empty stock.

14. The system of claim 12, further comprising the service provider accessing the database, with a computer or mobile device, and inputting details of the service into the database and the consumers accessing the bids database, with a computer or mobile device, and inputting details of their bid offers into the bids database.

15. The system of claim 12, wherein multiple bid offers and multiple expiration dates for their bid offers are set by the consumers in the consumer database into the bids database.

16. The system of claim 12, wherein the bid offers are saved on the bids database if the consumers input a verified credit card to back their bid offers.

17. The system of claim 12, wherein if an expiration date of the bid offers past, if the customer cancels the bid or if the bid offers are accepted by the service providers, the bid offers disappear from the bids database.

18. The system of claim 12, wherein the service providers use a manual or automated system to accept bid offers in the bids database having a certain price and certain characteristics at a certain point in time before the service takes place.

19. The system of claim 12, further comprising the service providers notifying the consumers of the acceptance of their bid offers by email or by issuing a confirmation number wherein customer receives a alert of acceptance via email, text or other communication means.

20. A non-transitory computer-readable storage medium carrying one or more sequences of one or more instructions which, when executed by one or more processors, cause an apparatus to at least perform the following steps:
bidding on a service by a customer;
setting an expiration date by the customer for acceptance of the bid by a service provider; and
accepting the bid of the customer by the service provider.
